(19) United States
(12) Patent Application Publication
(10) Pub. No.: US 2004/0095748 A1
(43) Pub. Date: May 20, 2004

(54) Waterfall lampshade

(76) Inventor: Junhon Lin, Diamond Bar, CA (US)

Correspondence Address: BACON & THOMAS, PLLC, 625 SLATERS LANE, FOURTH FLOOR, ALEXANDRIA, VA, 22314

(21) Appl. No.: 10/298,556

(22) Filed: Nov. 19, 2002

(51) Int. Cl. F21V 33/00

(52) U.S. Cl. 362/96; 362/318; 362/351

(57) ABSTRACT

The present invention is to provide a waterfall lampshade comprising a shroud, a liquid supply unit provided at a first end of the shroud, and a liquid collection unit provided at a second opposite end of the shroud so that liquid may flow cyclically through the surface of the shroud, the liquid supply unit, and the liquid collection unit. When the shroud in mounted on a support mechanism of the lamp, a light emitting element on the support mechanism may project light onto the surface of the shroud. At the same time, liquid continuously flows down along the surface of the shroud. As a result, a continuous change of brightness and darkness is shown on the shroud.

### FIELD OF THE INVENTION

The present invention relates to lamps and more particularly to such a lamp having an improved lampshade.

### BACKGROUND OF THE INVENTION

This world has become a diversified one as times evolves. A variety of quality consumer goods (e.g., lamps, tables, and chairs) are continuously developed. Such consumer goods are available not only in a fast pace but also with various designs and appearances. It is really amazing. Further, it brings a great convenience to our daily life. In one aspect, more people pay a great attention to quality of the consumer goods as they are available in a very fast pace. In this regard, we can know a relative development level of consumer goods of a certain country with respect to other countries by determining whether such consumer goods can provide a more convenient, effective service to the people of that country.

Typically, most people pay attention to practicability rather than design of consumer goods. For example, in the case of lamp in the past people always liked a lamp having a maximum illumination while consuming a least power as well as having a longer useful life. Recently, more people like consumer goods having personal characteristics and patterns. Hence, both the typical practicability and the design of consumer goods are concerned by people. For instance, clothes is not only designed to cover, protect the body as put on a person. In another example, watch is not only worn for recording time by a person. Moreover, for a modern person both clothes and watch are not only personal adornments but also served as a means for representing oneself. Likewise, a lamp is not only a source of light for indoor use but also an artistic article for decorating a house. In view of the above, fine design and appearance of a piece of consumer goods is a key to attract people to buy it. In other words, not only the practicability and convenience but also the design and appearance of a personal article with strong personal characteristics and patterns are concerned by people. As such, multifunctional, omnibus, and ergonomic consumer goods are the trend of newly developed ones.

As stated above, in one aspect more people pay attention to consumer goods with strong personal characteristics and patterns. To the contrary, they are still many very simple, dull consumer goods commercially available. For example, a person has to compare the designs and appearances of lamps A and B if they have the same price and the substantially same functionalities. It is known that goods are very competitive in selling. Thus, for surviving in this competitive market all major consumer goods (e.g., lamp) manufacturing companies dedicate to develop products with attractive design and appearance. Thus, continuing improvements in the lamp are constantly being sought.

### SUMMARY OF THE INVENTION

A primary object of the present invention is to provide a waterfall lampshade comprising a shroud, a liquid supply unit provided at a first end of the shroud, and a liquid collection unit provided at a second opposite end of the shroud so that liquid may flow cyclically through the surface of the shroud, the liquid supply unit, and the liquid collection unit. When the shroud in mounted on a support mechanism of the lamp, a light emitting element on the support mechanism may project light onto the surface of the shroud. At the same time, liquid continuously flows down along the surface of the shroud. As a result, a continuous change of brightness and darkness is shown on the shroud. By utilizing the invention, it is possible of overcoming the above drawbacks of the prior art which are that the many well known consumer goods have very simple, dull designs, thus contradicting the multifunctional, omnibus, and ergonomic features of newly developed ones. Moreover, the lamp of the invention is tailored to the development trend of consumer goods in the competitive market.

The above and other objects, features and advantages of the present invention will become apparent from the following detailed description taken with the accompanying drawings.

### BRIEF DESCRIPTION OF THE DRAWINGS

FIG. 1 is an exploded view of a lamp according to the invention;

FIG. 2 is a cross-sectional view of a first preferred embodiment of lamp according to the invention; and

FIG. 3 is a cross-sectional view of a second preferred embodiment of lamp according to the invention.

### DETAILED DESCRIPTION OF THE PREFERRED EMBODIMENTS

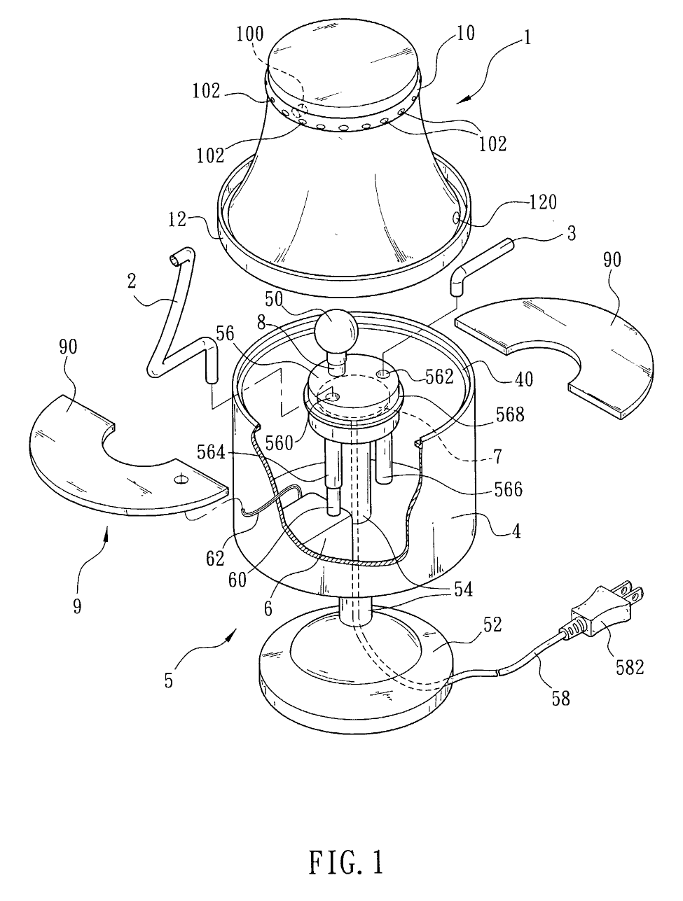

Referring to FIG. 1, there is shown a lamp in accordance with the invention. A shade of the lamp comprises a cone-shaped shroud 1 including a liquid supply unit 10 at a top periphery in which liquid (e.g., water as described by any of following preferred embodiments of the invention) flows from the liquid supply unit 10 down along a peripheral surface of the shroud 1, the liquid supply unit 10 including at least one inlet 100 and at least one outlet 102, a liquid collection unit 12 for collecting water flowed from the liquid supply unit 10 down along the peripheral surface of the shroud 1, the liquid collection unit 12 including at least one liquid collection port 120 at a bottom periphery, a supply pipe 2, and a drain pipe 3. One end of the supply pipe 2 is coupled to the inlet 100 and the other end thereof is coupled to a discharge port 60 of a pump 6 inside a liquid supply tank 4. One end of the drain pipe 3 is coupled to the liquid collection port 120 and the other end thereof is coupled to the liquid supply tank 4. As such, water stored in the liquid supply tank 4 may flow from the liquid supply tank 4 through the discharge port 60, the supply pipe 2, the inlet 100, the liquid supply unit 10, the outlet 102, the peripheral surface of the shroud 1, the liquid collection unit 12, the liquid collection port 120, and the drain pipe 3 to return to the liquid supply tank 4 in a cycle. A light emitting element (e.g., bulb) 50 of the lamp may project light onto the peripheral surface of the shroud 1 as the light emitting element 50 is mounted on a support mechanism 5. At the same time, water continuously flows down along the peripheral surface of the shroud 1 and the light is emitting toward all directions. As a result, a continuous change of brightness and darkness is shown on the shroud 1.

In a first preferred embodiment of the invention, the liquid supply tank 4 is provided between the top and the bottom of the support mechanism 5. The support mechanism 5 comprises a stand 52 at a distance from the bottom. The stand 52 serves to support the support mechanism 5 on a planar surface. A central post 54 is extended upward from the stand 52. The light emitting element 50 is disposed on the top of the post 54 distal from the stand 52. A fastening section 56 is provided on the post 54 adjacent the light emitting element 50. The fastening section 56 comprises an intake orifice 560 and an intake port 562 in which the intake orifice 560 has one end coupled to the supply pipe 2 and the other end coupled to one end of the first guide tube 564. The other end of the first guide tube 564 is extended into a position proximate the bottom of the liquid supply tank 4 or directly into the bottom of the liquid supply tank 4. The discharge port 60 of the pump 6 is coupled to the other end of the first guide tube 564. Preferably, a suction port of the pump 6 is located at a lowest horizontal position of the liquid supply tank 4. One end of the intake port 562 of the fastening section 56 is coupled to the drain pipe 3 and the other end thereof is coupled to one end of a second guide tube 566. The other end of the second guide tube 566 is extended into a position proximate the bottom of the liquid supply tank 4 or directly into the bottom of the liquid supply tank 4.

Thus, water is pressurized by the pump 6 as it leaves the liquid supply tank 4. The high pressure water may flow from the suction port of the pump 6 through the discharge port 60, the first guide tube 564, the intake orifice 560, the supply pipe 2, the inlet 100, the liquid supply unit 10, and the outlet 102. And in turn, water flows down along the peripheral surface of the shroud 1 through the liquid collection unit 12, the liquid collection port 120, the drain pipe 3, the intake port 562, and the second guide tube 566 to return to the liquid supply tank 4 by its own weight. As a result, water stored in the liquid supply tank 4 at a low elevation can be fed to the liquid supply unit 10 at a high elevation. Hence, once the pump 6 is started and there is sufficient water in the liquid supply tank 4, water can continuously flow from the outlet 102 of the liquid supply unit 10 down to the peripheral surface of the shroud 1 prior to flowing into the liquid collection unit 12. Moreover, as stated above, when the light emitting element 50 projects light onto the peripheral surface of the shroud 1, a continuous change of brightness and darkness is shown on the shroud 1.

In the preferred embodiment, the outlet 102 is located at the liquid supply unit 10 opposite to the liquid collection unit 12, i.e., on the peripheral surface of the shroud 1. Once water flows out of the outlet 102, water may flow down along the peripheral surface of the shroud 1 to the liquid collection unit 12 without spitting out of the shroud 1. A power cord 58 is provided in the post 54. Further, the power cord 58 has one end coupled to a circuit board 7 and the other end extended along the post 54 through and beyond the stand 52. A plug 582 is formed at an open end of the power cord 58. The circuit board 7 is coupled to a socket 8 which is served for fastening the light emitting element 50. Once the plug 582 is inserted into an indoor outlet, electric power can be supplied to the light emitting element 50 through the power cord 58, the circuit board 7, and the socket 8. In this case the light emitting element 50 can continuously emit light as long as the power is on. Further, there is no contact between the light emitting element 50 and water. As a result, a potential short circuit or current leakage is avoided.

A power cord 62 of the pump 6 is extended out of the liquid supply tank 4. Also, a flange 40 is formed on an inner periphery of the liquid supply tank 4 for preventing water from spitting out of the liquid supply tank 4 as water flows back to the liquid supply tank 4 or foreign objects from falling into the liquid supply tank 4. A flange 40 is formed on an outer periphery of the fastening section 56. A cover 9 is disposed on the flange 40 and the other flange 568. The cover 9 consists of two half ring-shaped plates 90 which are placed on the top of the liquid supply tank 4 being supported by the flanges 40 and 568. As a result, the liquid supply tank 4 is covered by the cover 9.

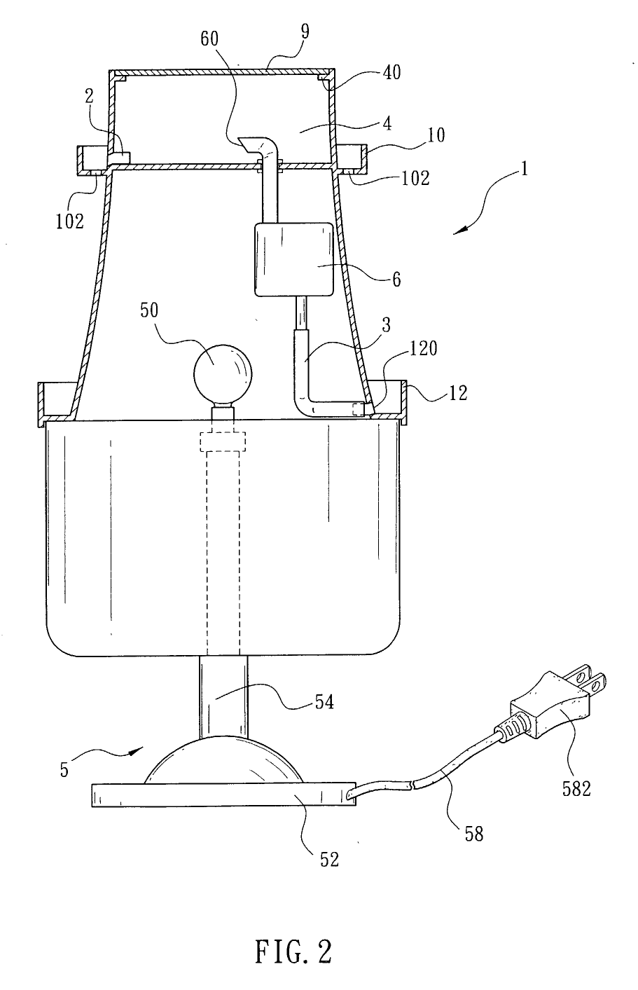

Referring to FIG. 2, there is shown a first preferred embodiment of the invention. The liquid supply tank 4 is located on the shroud 1 at a position higher than that of the liquid supply unit 10. The suction port of the pump 6 is coupled to the drain pipe 3 and the discharge port 60 thereof is coupled to the liquid supply tank 4. As such, water stored in the liquid supply tank 4 may flow out of the liquid supply tank 4 through the liquid supply unit 10, the outlet 102, the peripheral surface of the shroud 1, and the liquid collection unit 12 by its own weight. And in turn, the pump 6 is activated to draw water out of the liquid collection unit 12. Further, water flows through the liquid collection port 120 and the drain pipe 3 to return to the liquid supply tank 4. As stated above, the flange 40 is formed on the inner periphery of the liquid supply tank 4 opposite to the liquid supply unit 10. The cover 9 is tightly fitted on the flange 40 for completely covering the liquid supply tank 4. As an end, water is prevented from spitting out of the liquid supply tank 4 as water flows back to the liquid supply tank 4. Further, foreign objects are prevented from falling into the liquid supply tank 4 by the provision of the cover 9. Furthermore, a user may pour water into the liquid supply tank 4 by lifting the cover 9.

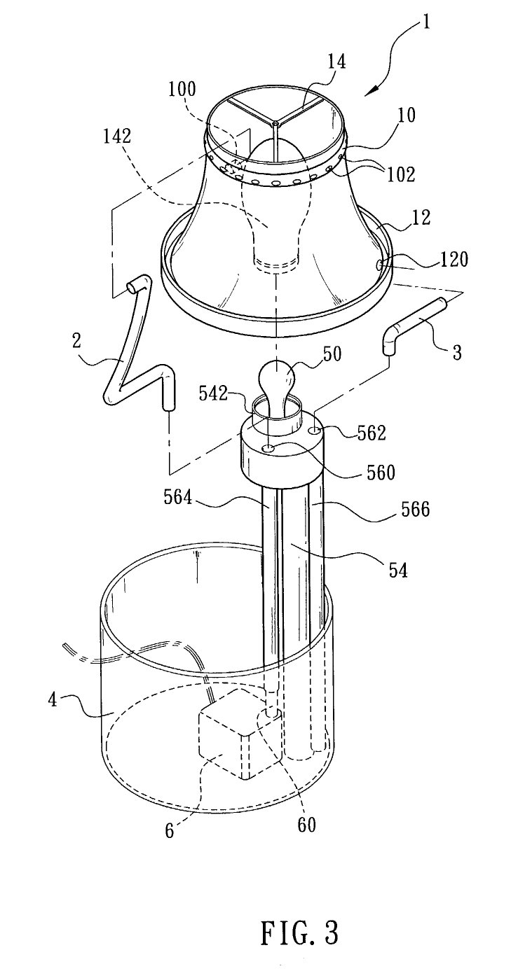

Referring to FIG. 3, there is shown a second preferred embodiment of the invention. As shown, the liquid supply tank 4 is provided at a position opposite to the shroud 1. The bottom of the liquid supply tank 4 is supported on a planar surface. A post 54 is extended upward from the liquid supply tank 4 to the shroud 1. As such, water may flow between the shroud 1 and the liquid supply tank 4. A mount 14 is provided at a position of an inner periphery of the shroud 1 adjacent the top of the liquid supply unit 10. The mount 14 is extended toward the other opposite position of the inner periphery of the shroud 1 to form an engagement member 142 which is in turn coupled to a mating engagement member 542 of the post 54.

While the invention has been described by means of specific embodiments, numerous modifications and variations could be made thereto by those skilled in the art without departing from the scope and spirit of the invention set forth in the claims.

What is claimed is:

1. A waterfall lampshade comprising:
a shroud;
a liquid supply unit provided at a first end of the shroud so that liquid stored in the liquid supply unit is capable of leaving the liquid supply unit to flow down along a surface of the shroud; and
a liquid collection unit provided at a second opposite end of the shroud for storing liquid which leaves the liquid supply unit by passing through the surface of the shroud.

2. The lampshade of claim 1, wherein the liquid supply unit comprises a supply pipe, at least one inlet having one end coupled to one end of the supply pipe, at least one outlet so that liquid is capable of leaving the outlet, a liquid collection unit including at least one liquid collection port, and a drain pipe having one end coupled to the liquid collection port so that the liquid collection port is capable of collecting liquid prior to feeding to the liquid collection unit.

3. The lampshade of claim 1, wherein the outlet is located at the liquid supply unit opposite to the liquid collection unit and disposed on the surface of the shroud so that liquid is capable of leaving the outlet for flowing down along the surface of the shroud to the liquid collection unit.

4. The lampshade of claim 2, further comprising a post disposed between the shroud and the liquid supply tank, the post comprising:
a light emitting element disposed on its top distal from the shroud;
a fastening section adjacent the light emitting element, the fastening section including an intake orifice having one end coupled to the other end of the supply pipe and an intake port having one end coupled to the other end of the drain pipe;
a first guide tube having one end coupled to the other end of the intake orifice and the other end extended into the liquid supply tank for coupling to a discharge port of a pump; and
a second guide tube having one end coupled to the other end of the intake port and the other end extended into the liquid supply tank.
